(19) United States
(12) Patent Application Publication
(10) Pub. No.: US 2026/0370462 A1
(43) Pub. Date: Nov. 19, 2026

(54) SYSTEM AND METHOD FOR PRIVACY-PRESERVING FEDERATED LEARNING

(71) Applicant: Dell Products L.P., Round Rock, TX (US)

(72) Inventors: Vaibhav Soni, Round Rock, TX (US); Charles D. Robison, Buford, GA (US); Nicholas D. Grobelny, Evergreen, CO (US)

(73) Assignee: Dell Products L.P., Round Rock, TX (US)

(21) Appl. No.: 19/206,707

(22) Filed: May 13, 2025

(51) Int. Cl. H04L 9/08; G06N 20/00; H04L 9/00; H04L 9/40

(52) U.S. Cl. CPC H04L 9/0861; G06N 20/00; H04L 9/008; H04L 63/0421

(57) ABSTRACT

Systems and methods for Privacy-Preserving Federated Learning are described. According to one embodiment, an Information Handling System (IHS) may include multiple computing devices, and a memory storing instructions that may be executed by a processor to anonymously attest the local learning module configured on each of the computing devices, using the local learning module, generate model updates for a global model from user data obtained from the IHS, and send the generated model updates to a federated learning service, wherein the federated learning service uses the model updates to update the global model.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Federated learning generally refers to a machine learning process that trains a machine learning algorithm using multiple independent nodes each using its own dataset. Federated learning may train a global machine learning algorithm, for instance deep neural networks, based on multiple local datasets contained in local nodes (e.g., clients) without explicitly exchanging data samples. The learning is solved by a federation of participating devices often coordinated by a central server. Each participating node has a local training dataset which is not uploaded to the server or shared with other clients. Instead, each client computes an update to a current global model maintained by the server. The clients communicate updates, but not the training dataset, to the server. The server aggregates the received updates to update the global model. The resulting shared model can be trained by learning from the training of the clients, thus allowing users to reap the benefits of shared models trained from the data of the clients without having to transfer user data from the clients. This may have particular usefulness in situations where the exchange of sensitive or personal data is precluded (e.g., medical information, Internet of Things devices, personal devices such as smart phones).

### SUMMARY

Systems and methods for Privacy-Preserving Federated Learning are described. According to one embodiment, an Information Handling System (IHS) may include multiple computing devices, and a memory storing instructions that may be executed by a processor to anonymously attest the local learning module configured on each of the computing devices, using the local learning module, generate model updates for a global model from user data obtained from the IHS, and send the generated model updates to a federated learning service, wherein the federated learning service uses the model updates to update the global model.

According to another embodiment, an anonymous attestation federated learning method includes the steps of anonymously attesting a local learning module configured on each of a plurality of computing devices, using the local learning module, generating model updates for a global model from user data obtained from an Information Handling System (IHS), and sending the generated model updates to a federated learning service. The federated learning service uses the model updates to update the global model.

According to yet another embodiment, a non-transitory memory storage device with program instructions stored thereon that, upon execution by an Information Handling System (IHS), cause the IHS to anonymously attest a local learning module configured on each of a plurality of computing devices, using the local learning module, generate model updates for a global model from user data obtained from the HIS, and send the generated model updates to a federated learning service, wherein the federated learning service uses the model updates to update the global model.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 shows an example of an IHS that may be configured to implement an anonymous attestation federated learning system and method for a software identity issuance agent according to one embodiment of the present disclosure.

FIG. 2 illustrates an example anonymous attestation federated learning system that may provide a framework for secure and privacy-preserving federated learning according to one embodiment of the present disclosure.

FIG. 3 illustrates an example anonymous attestation federated learning method that may be used to provide federated learning while preserving user privacy according to one embodiment of the present disclosure.

FIG. 4 Illustrates another anonymous attestation federated learning method showing additional details of how the anonymous attestation federated learning system may be used to provide scalability and efficiency of the federated learning process that may be achieved through secure aggregation and decentralized fine-tuning according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

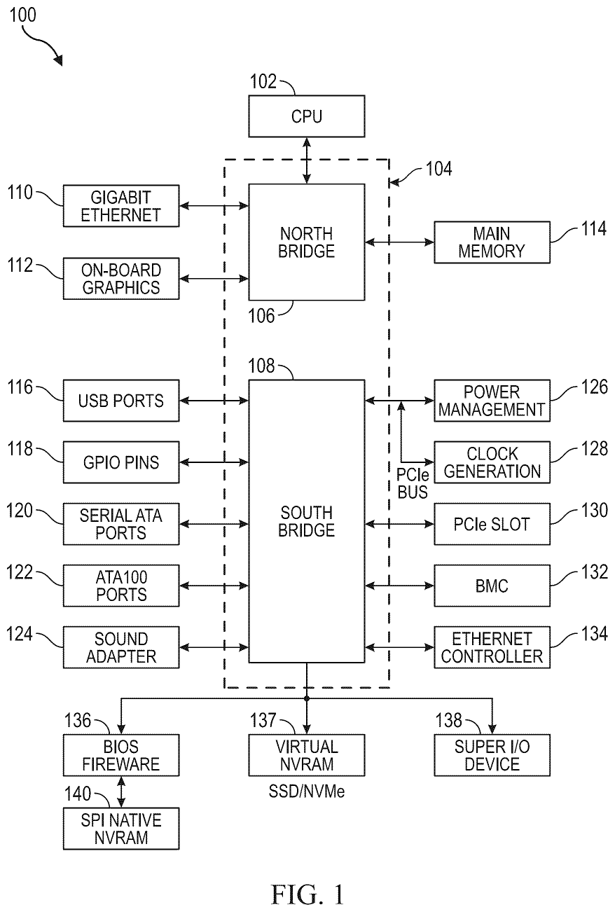

An IHS may include random access memory (RAM), one or more processing resources such as a central processing unit (CPU) or hardware or software control logic, ROM, and/or other types of nonvolatile memory. Additional components of an IHS may include one or more disk drives, one or more network ports for communicating with external devices as well as various input and output (I/O) devices, such as a keyboard, a mouse, touchscreen and/or a video display. An IHS may also include one or more buses operable to transmit communications between the various hardware components. A more detailed example of an IHS is described with respect to FIG. 1. It should be appreciated that although certain embodiments are discussed in the context of a personal computing device, other embodiments may utilize other types of IHSs.

Recently, cloud native workload authentication techniques have been developed to provide a security identity to each of multiple applications (e.g., workloads) running on an IHS. One example of such a workload authentication technique may include a Secure Production Identity Framework for Everyone (SPIFFE) protocol that may run a suitable agent, such as a SPIFFE runtime environment (SPIRE) on the IHS for attesting the workloads. Other workload authentication techniques may exist, such as OS for Crypto SWID, Linux OS (EL0-X) for UID/PID, and an external or local service for assigned unique software (e.g., APEX). These workload authentication techniques may provide a security identity (ID) to each of the workloads and enable an individual application to identify and cryptographically authenticate other applications that it needs to communicate with, such as SPIFFE Verifiable Identity Documents (SVIDs) as used with SPIFFE compliant techniques. Additionally, the SPIFFE SPIRE agent may provide a workload API for any workload (e.g., application) that wants to leverage it.

Federated learning provides collaborative model training across multiple devices without sharing raw data. This approach is crucial for privacy-sensitive applications, such as healthcare and finance where regulations require strict adherence to protection of personally identifiable information (PII). However, ensuring the trustworthiness of participating devices and protecting data privacy have heretofore remained key challenges for proper federated learning. Moreover, existing federated learning frameworks often lack robust mechanisms to prove device authenticity and integrity (e.g., attestation). Malicious or tampered/compromised devices could participate in the training process leading to the compromise of model's accuracy or exfiltration of sensitive information. Additionally, traditional methods may not fully protect user data and model updates during transmission and aggregation.

Federated learning is a widely studied approach enabling decentralized model training while maintaining data privacy by keeping raw data on local devices. Current solutions often focus on privacy-preserving techniques, such as, GOOGLE's FEDERATED LEARNING FRAMEWORK or OPENMINDED's PRIVACY PRESERVING AI. The FEDERATED LEARNING FRAMEWORK implements secure aggregation of model updates using encryption and differential privacy. However, it may lack robust mechanisms to validate device authenticity and integrity. PRIVACY PRESERVING AI incorporates differential privacy and encrypted computation, but often does not address risks from compromised or tampered devices.

Device attestation has been explored to establish the integrity of participating devices, such as with a Trusted Platform Module (TPM), or TEEs (e.g., ARM TrustZone, Intel SGX, etc.). The TPM may be used for hardware-based integrity verification, but traditional TPM approaches directly tie device identity to the attestation process, potentially compromising privacy. Additionally, TEEs may provide a trusted environment for secure processing, but these solutions do not inherently anonymize device attestation or address the scalability of federated learning.

Mechanisms for ensuring the authenticity of data in distributed systems include Public Key Infrastructure (PKI) or digital signatures in blockchain. PKI is commonly used for signing and verifying data. However, conventional implementations expose device identities, making them unsuitable for privacy-preserving federated learning. With regard to digital signatures in blockchain they may offer decentralized authenticity but are computationally expensive and not optimized for dynamic federated learning environments.

Existing privacy-preserving mechanisms focus primarily on safeguarding data during transmission and aggregation, such as with homomorphic encryption or differential privacy. Homomorphic encryption provides encrypted data computations but often incurs significant computational overhead, impacting scalability. Moreover, differential privacy provides noise-based protections, but does not address the risks associated with malicious devices injecting poisoned updates.

As such, the prior art, in many cases, lacks mechanisms to ensure only trusted devices contribute to federated learning without compromising device anonymity. Existing solutions either reveal device-specific details or fail to scale anonymized attestation to support large, dynamic device ecosystems. Additionally, while mechanisms for data signing exist, they often do not incorporate anonymized alias signing to ensure privacy and trust simultaneously. Most federated learning frameworks focus on isolated privacy components (e.g., differential privacy or encryption) without integrating trust, privacy, and scalability into a unified framework. As will be described in detail herein below, embodiments of the present disclosure provide an anonymous attestation system and method for privacy-preserving federated learning that provides a robust framework for secure and privacy-preserving federated learning, and addresses the need for trust in device authenticity while maintaining the privacy of user data and model updates.

FIG. 1 shows an example of an IHS 100 that may be configured to implement an anonymous attestation federated learning system and method according to one embodiment of the present disclosure. It should be appreciated that although certain embodiments described herein may be discussed in the context of a desktop or server computer, other embodiments may be utilized with virtually any type of IHS 100. Particularly, the IHS 100 includes a baseboard or motherboard, to which is a printed circuit board (PCB) to which components or devices are mounted by way of a bus or other electrical communication path. For example, Central Processing Unit (CPU) 102 operates in conjunction with a chipset 104. CPU 102 is a processor that performs arithmetic and logic necessary for the operation of the IHS 100.

Chipset 104 includes northbridge 106 and southbridge 108. Northbridge 106 provides an interface between CPU 102 and the remainder of the IHS 100. Northbridge 106 also provides an interface to a random access memory (RAM) used as main memory 114 in the IHS 100 and, possibly, to on-board graphics adapter 112. Northbridge 106 may also be configured to provide networking operations through Ethernet adapter 110. Ethernet adapter 110 is capable of connecting the IHS 100 to another IHS 100 (e.g., a remotely located IHS 100) via a network. Connections which may be made by Ethernet adapter 110 may include local area network (LAN) or wide area network (WAN) connections. Northbridge 106 is also coupled to southbridge 108.

Southbridge 108 is responsible for controlling many of the input/output (I/O) operations of the IHS 100. In particular, southbridge 108 may provide one or more universal serial bus (USB) ports 116, sound adapter 124, Ethernet controller 134, and one or more general purpose input/output (GPIO) pins 118. Southbridge 108 may also provide a bus for interfacing peripheral card devices such as PCIe slot 130. In some embodiments, the bus may include a peripheral component interconnect (PCI) bus. Southbridge 108 may also provide baseboard management controller (BMC) 132 for use in managing the various components of the IHS 100. Power management circuitry 126 and clock generation circuitry 128 may also be utilized during operation of southbridge 108.

Additionally, southbridge 108 is configured to provide one or more interfaces for connecting mass storage devices to the IHS 100. For instance, in one embodiment, southbridge 108 may include a serial advanced technology attachment (SATA) adapter for providing one or more serial ATA ports 120 and/or an ATA100 adapter for providing one or more ATA100 ports 120. Serial ATA ports 122 and ATA100 ports 122 may be, in turn, connected to one or more mass storage devices storing an operating system (OS) and application programs.

An OS may comprise a set of programs that controls operations of the IHS 100 and allocation of resources. An application program is software that runs on top of the OS and uses computer resources made available through the OS to perform application-specific tasks desired by the user.

Mass storage devices connected to southbridge 108 and PCIe slot 130, and their associated computer-readable media provide non-volatile storage for the IHS 100. Although the description of computer-readable media contained herein refers to a mass storage device, such as a hard disk or CD-ROM drive, it should be appreciated by a person of ordinary skill in the art that computer-readable media can be any available media on any memory storage device that can be accessed by the IHS 100. Examples of memory storage devices include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices.

A low pin count (LPC) interface may also be provided by southbridge 108 for connecting Super I/O device 138. Super I/O device 138 is responsible for providing a number of I/O ports, including a keyboard port, a mouse port, a serial interface, a parallel port, and other types of input/output ports.

The LPC interface may connect a computer storage media such as a ROM or a flash memory such as a non-volatile random access memory (NVRAM) for storing BIOS/firmware 136 that includes BIOS program code containing the basic routines that help to start up the IHS 100 and to transfer information between elements within the IHS 100. BIOS/firmware 136 comprises firmware compatible with the Extensible Firmware Interface (EFI) Specification and Framework.

The LPC interface may also be utilized to connect virtual NVRAM 137 (e.g., SSD/NVMe) to the IHS 100. The virtual NVRAM 137 may be utilized by BIOS/firmware 136 to store configuration data for the IHS 100. In other embodiments, configuration data for the IHS 100 may be stored on the same virtual NVRAM 137 as BIOS/firmware 136. The IHS 100 may also include a SPI native NVRAM 140 coupled to the BIOS 136.

BMC 132 may include non-volatile memory having program instructions stored thereon that enable remote management of the IHS 100. For example, BMC 132 may enable a user to discover, configure, and manage the IHS 100, setup configuration options, resolve and administer hardware or software problems, etc. Additionally or alternatively, BMC 132 may include one or more firmware volumes, each volume having one or more firmware files used by the BIOS' firmware interface to initialize and test components of the IHS 100.

As a non-limiting example of BMC 132, the integrated DELL Remote Access Controller (iDRAC) from DELL, INC. is embedded within DELL POWEREDGE servers and provides functionality that helps information technology (IT) administrators deploy, update, monitor, and maintain servers with no need for any additional software to be installed. The iDRAC works regardless of OS or hypervisor presence from a pre-OS or bare-metal state because iDRAC is embedded within the IHS 100 from the factory.

It should be appreciated that, in other embodiments, the IHS 100 may comprise other types of computing devices, including hand-held computers, embedded computer systems, personal digital assistants, and other types of computing devices. It is also contemplated that the IHS 100 may not include all of the components shown in FIG. 1, may include other components that are not explicitly shown in FIG. 1, or may utilize a different architecture.

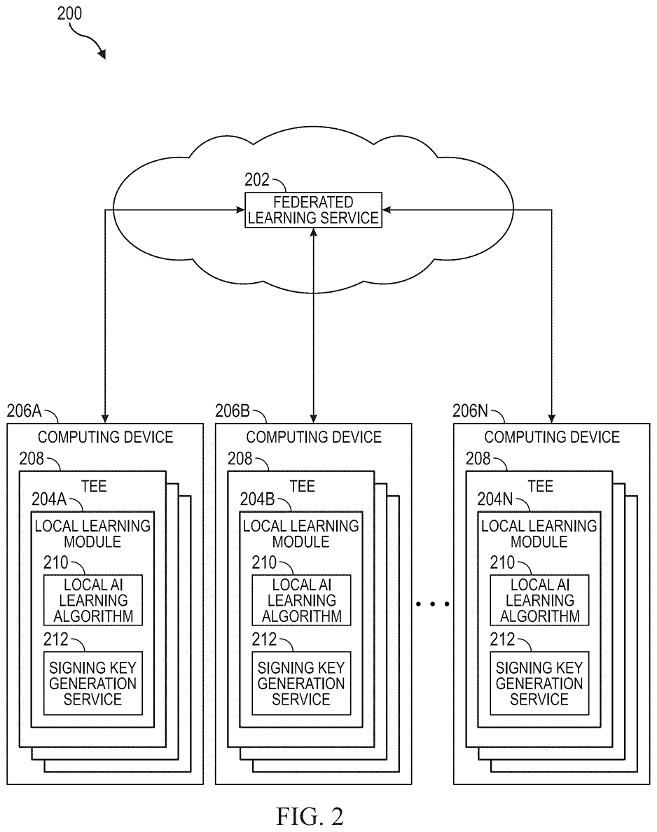

FIG. 2 illustrates an example anonymous attestation federated learning system 200 that may provide a framework for secure and privacy-preserving federated learning according to one embodiment of the present disclosure. The anonymous attestation federated learning system 200 generally includes a federated learning service 202 in communication with multiple local learning modules 204a-n (collectively 204) that are each installed computing devices 206a-n (collectively 206). Each computing device 206 includes one or more Trusted Execution Environments (TEEs) 208 or Enclaves. Many IHSs nowadays are configured with multiple processors (e.g., CPUs, GPUs, smartNICs, DPUs, etc.) that each form their own individual compute domains in which each compute domain usually can be referred to as a TEE or Enclave. As will be described in detail herein below, each of the local learning modules 204 includes an alias signing key generation service 212 that generates an alias signing key for attesting to the federated learning service 202, and a local AI learning algorithm 210 that generates model updates associated with its respective TEE 208, sends those model updates to the federated learning service 202 for providing federated learning while maintaining the privacy of user data and model updates.

While the present embodiment is described as being attested using a TEE 208, it should be appreciated that in other embodiments, each local learning module 204 may be attested using other integrity management mechanisms, such as via the use of a Trusted Platform Module (TPM). In some embodiments, either of the TEEs 208 or a TPM may be considered to be a hardware device configured to function as a Hardware Root-of-Trust (HWRoT);

The anonymous attestation federated learning system 200 provides a unified privacy-preserving federated learning framework with anonymous hardware attestation. This framework incorporates an anonymous hardware attestation, customer signatory for data authenticity, and TEE integration. With anonymous hardware attestation, each device performs self-attestation to verify its hardware and software integrity. Instead of sending full attestation details, the device sends an anonymized proof to the server, in the form of class-level attestation evidence. The attestable software loads on the hardware and establishes a unique software identity. The software then verifies the unique hardware attestation evidence, such as via a TPM quote. The local learning module 204 passes verifiable hardware measurements back to the federated learning service 202 (e.g., a remote verifier) using a non-hardware-related software signing key (e.g., an alias key). The federated learning service 202 may then verify the proof, ensuring only trusted devices participate in training. The customer signatory for data authenticity may ensure that the learning data is signed by the customer hardware, verifying its authenticity and preventing tampering. Also, the TEE Integration may securely store and manage cryptographic keys used for attestation and encryption.

The anonymous attestation federated learning system 200 may provide a robust framework for secure and privacy-preserving federated learning. Additionally, it may address the need for trust in device authenticity while maintaining the privacy of user data and model updates. Each local learning module 204 includes an alias signing key generation service 212 that performs a self-attestation process, cryptographically verifying its hardware components, firmware, and software integrity. In one embodiment, this could involve a Trusted Platform Module (TPM) 214 or other Secure Enclave. Instead of sending full attestation details, each local learning module 204 may send a minimal, anonymized proof of attestation to the federated learning service 202. This proof confirms that the attestation was successful without revealing specific hardware or software information about each computing device 206. This feature aligns with the aspect of sending only “Class info” instead of “instance” details. The federated learning service 202 verifies the anonymized proof, ensuring that the device meets the required security and integrity standards before allowing it to participate in federated learning.

In one embodiment, the local learning module 204 may employ homomorphic encryption to encrypt model updates or gradients before the data leaves the TEE 208. This allows the server to aggregate updates without decrypting them, thus preserving data privacy. In one embodiment, each local learning module 204 may add calibrated noise (e.g., differential privacy) to model updates or gradients by the AI learning algorithm 210 to provide further privacy guarantees against potential inference attacks. In another embodiment, each local learning module 204 may fine-tune the global model with personalized layers or adapters, such that customization to individual user data and preferences may be enabled without sharing sensitive information. In yet another embodiment, the local learning module 204 may utilize techniques like sparsification, quantization, and model compression to reduce the amount of data transmitted between devices and the server.

Each local learning module 204 may leverage TEEs 208 (e.g., ARM TrustZone, Intel SGX, etc.) to securely store and manage cryptographic keys used for attestation and encryption. This ensures that keys are protected from unauthorized access. In some embodiments, the anonymous attestation federated learning system 200 may provide a Customer Signatory for Data Authenticity that allows customers (e.g., data owners) to sign the learning data generated on their devices. This signature verifies the authenticity and integrity of the data, ensuring that the model is trained on trusted data from authorized sources.

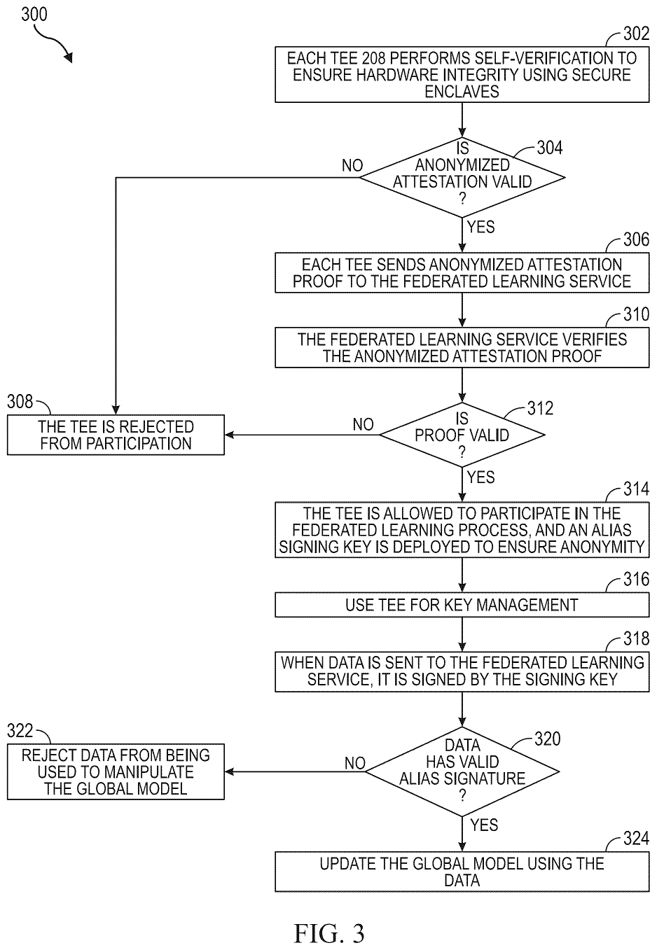

FIG. 3 illustrates an example anonymous attestation federated learning method 300 that may be used to provide federated learning while preserving user privacy according to one embodiment of the present disclosure. Additionally or alternatively, certain steps of the anonymous attestation federated learning method 300 may be performed by the anonymous attestation federated learning system 200 as described above with reference to FIG. 2. Initially, a copy of the local learning module 204 may be installed on each TEE 208 of each computing device 206 that is to participate in the federated learning.

At step 302, each TEE 208 performs self-verification to ensure hardware integrity using Secure Enclaves. In one embodiment, the local learning module 204 may perform self-verification using a Trusted Platform Module (TPM) configured on the computing device 206. Essentially, the attestation process generates anonymized proof of device authenticity. At step 304, it is determined whether hardware integrity has been verified. If so, processing continues at step 306; otherwise, processing continues at step 308 in which the device (e.g., local learning module 204) is rejected from being used with the anonymous attestation federated learning system 200.

At step 306, each TEE 208 sends anonymized attestation proof to the federated learning service 202. Next at step 310, the federated learning service 202 verifies the anonymized attestation proof. The federated learning service 202 may then verify whether the proof is valid at step 312. If so, processing continues at step 314; otherwise, processing continues at step 308 in which the device is rejected from participating with the anonymous attestation federated learning system 200. At step 314, the TEE 208 is allowed to participate in the federated learning process, and an alias signing key is deployed to ensure anonymity. For example, the alias signing key may provide proof of the local learning module 204 executed in the TEE, yet includes no specific information about the TEE or the computing device in which it is being executed.

At step 316, the TEE 208 may be used for key management using the alias signing key generation service 212. That is, the TEE 208 may function as a root-of-trust for the alias signing key. When user data is sent to the federated learning service 202 at step 318, it is signed by the alias signing key. In one embodiment, participating devices may encrypt their model updates using homomorphic encryption and apply differential privacy techniques to protect sensitive user information. Thus, encrypted and privacy-preserved updates are allowed to be transmitted to the federated learning service 202. The federated learning service 202 aggregates the encrypted updates from all trusted devices. The aggregated results are used to update the global federated model, ensuring scalability and privacy. Each TEE 208 may perform fine-tuning of the global model locally to personalize the model based on individual user data. In one embodiment, the TEE 208 may be used for secure key management during this phase. Each TEE 208 may sign the learning data using the deployed alias signing key to ensure data authenticity.

At step 320, the federated learning service 202 may determine whether the data possesses a valid alias signature. If not, processing continues at step 322 in which the data is rejected from being used to manipulate the global model; otherwise, processing continues at step 324 in which the data may be used to update the global model. That is, the federated learning service 202 determines whether the data is deemed to be trustworthy, and may thus be used for training the global model using secure and authentic data. If, however, the data is invalid, it is rejected to prevent tampering or malicious participation.

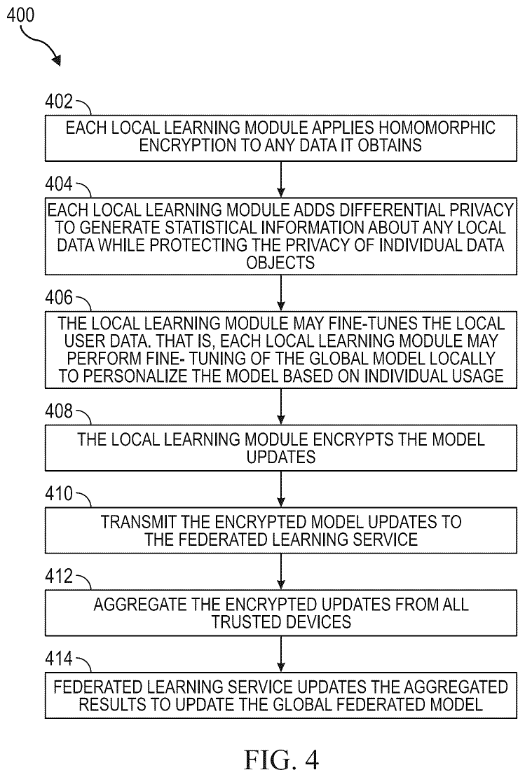

FIG. 4 Illustrates another anonymous attestation federated learning method 400 showing additional details of how the anonymous attestation federated learning system 200 may be used to provide scalability and efficiency of the federated learning process may be achieved through secure aggregation and decentralized fine-tuning according to one embodiment of the present disclosure. The anonymous attestation federated learning method 400 may be continually performed for updating of the global model over time at ongoing intervals. Initially, the integrity of the local learning module 204 may be attested against at least one of a TEE 208 or other attestation mechanism (e.g., TPM 212) configured on each participating computing device 206. That is, each device (e.g., local learning module 204) may perform self-verification to ensure hardware integrity using a TPM 212 or a TEE 208 (e.g., secure enclave), which may generate an anonymized proof of device authenticity. Additionally, the local learning module 204 may be verified by the federated learning service 202.

In general, steps 402-406 describe actions that may be taken by each local learning module 204 to train with trusted data on its respective computing device 206. It should be appreciated that steps 402-406 may be performed in any particular order and are not limited to the particular sequence of steps as explicitly described herein., Initially at step 402, the local learning module 204 may fine-tune any locally obtained data. That is, each local learning module 204 may perform fine-tuning of the global model locally to personalize the model based on individual usage. In one embodiment, the TEE 208 may be used for secure key management during this phase. Thereafter at step 404, each local learning module 204 may add differential privacy to generate statistical information about any local data while protecting the privacy of individual data objects. That is, participating devices may encrypt their model updates using homomorphic encryption and apply differential privacy techniques to protect sensitive user information. At step 406, each local learning module 204 may then apply homomorphic encryption to any data it obtains.

The local learning module 204 may then encrypt the model updates at step 408, and transmit the encrypted model updates to the federated learning service 202 at step 410. When the federated learning service 202 receives the model updates, it may then aggregate the encrypted updates from all trusted devices at step 412. The aggregated results may be used to update the global federated model at step 414, thus ensuring scalability and privacy.

The steps of the anonymous attestation federated learning method 400 may be repeatedly performed to continually update the global model. Nevertheless, when use of the anonymous attestation federated learning method 400 is no longer needed or desired, the process ends.

Although FIGS. 3 and 4 describe how a federated learning process may be performed in which trust and integrity are ensured through verification mechanisms, and scalability and efficiency are achieved through secure aggregation and decentralized fine-tuning, the features of the process may be embodied in other specific forms without deviating from the spirit and scope of the present disclosure. For example, the process may perform additional, fewer, or different operations than those described in the present examples. For another example, the process may be performed in a sequence of steps different from that described above. For yet another example, the process may be performed by components other than what is described herein above.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterward be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a plurality of computing devices that are each configured with a local learning module;
a processor;
a memory coupled to the processor, the memory having program instructions that, upon execution by the processor, cause the IHS to:
anonymously attest the local learning module configured on each of the computing devices;
using the local learning module, generate model updates for a global model from user data obtained from the IHS; and
send the generated model updates to a federated learning service, wherein the federated learning service uses the model updates to update the global model.

2. The IHS of claim 1, wherein the program instructions, upon execution by the processor, further cause the IHS to encrypt the data using homomorphic encryption.

3. The IHS of claim 1, wherein the program instructions, upon execution by the processor, further cause the IHS to add calibrated noise to the data to remediate any potential inference attacks.

4. The IHS of claim 1, wherein the program instructions, upon execution by the processor, further cause the IHS to perform at least one of sparsification, quantization, or model compression on the user data to reduce the amount of data transmitted between devices and the server.

5. The IHS of claim 1, wherein the program instructions, upon execution by the processor, further cause the IHS to anonymously attest the local learning module using a Trusted Execution Environment (TEE) configured on the computing device.

6. The IHS of claim 1, wherein the program instructions, upon execution by the processor, further cause the IHS to anonymously attest the local learning module using a Trusted Platform Module (TPM) configured on the computing device.

7. The IHS of claim 1, wherein the program instructions, upon execution by the processor, further cause the IHS to anonymously attest the local learning module using a hardware device configured to function as a Hardware Root-of-Trust (HWRoT).

8. The IHS of claim 1, wherein the program instructions, upon execution by the processor, further cause the IHS to generate an alias signing key that is void of any personally identifiable information (PII) associated with a user of the computing device; send the alias signing key to the federated learning service, wherein the federated learning service used the alias signing key to attest the local learning service.

9. An anonymous attestation federated learning method comprising:
anonymously attesting a local learning module configured on each of a plurality of computing devices;
using the local learning module, generating model updates for a global model from user data obtained from an Information Handling System (IHS); and
sending the generated model updates to a federated learning service, wherein the federated learning service uses the model updates to update the global model.

10. The anonymous attestation federated learning method of claim 9, further comprising encrypting the data using homomorphic encryption.

11. The anonymous attestation federated learning method of claim 9, further comprising adding calibrated noise to the data to remediate any potential inference attacks.

12. The anonymous attestation federated learning method of claim 9, further comprising performing at least one of sparsification, quantization, or model compression on the user data to reduce the amount of data transmitted between devices and the server.

13. The anonymous attestation federated learning method of claim 9, further comprising anonymously attesting the local learning module using at least one of a Trusted Execution Environment (TEE) configured on the computing device or a Trusted Platform Module (TPM) configured on the computing device.

14. The anonymous attestation federated learning method of claim 9, further comprising generating an alias signing key that is void of any personally identifiable information (PII) associated with a user of the computing device; sending the alias signing key to the federated learning service, wherein the federated learning service uses the alias signing key to attest the local learning service.

15. A non-transitory memory storage device having program instructions stored thereon that, upon execution by an Information Handling System (IHS), cause the IHS to:
anonymously attest a local learning module configured on each of a plurality of computing devices;
using the local learning module, generate model updates for a global model from user data obtained from the IHS; and
send the generated model updates to a federated learning service, wherein the federated learning service uses the model updates to update the global model.

16. The non-transitory memory storage device of claim 15, wherein the program instructions, upon execution by the processor, further cause the IHS to encrypt the data using homomorphic encryption.

17. The non-transitory memory storage device of claim 15, wherein the program instructions, upon execution by the processor, further cause the IHS to add calibrated noise to the data to remediate any potential inference attacks.

18. The non-transitory memory storage device of claim 15, wherein the program instructions, upon execution by the processor, further cause the IHS to anonymously attest the local learning module using a Trusted Execution Environment (TEE) configured on the computing device.

19. The non-transitory memory storage device of claim 15, wherein the program instructions, upon execution by the processor, further cause the IHS to anonymously attest the local learning module using a Trusted Platform Module (TPM) configured on the computing device.

20. The non-transitory memory storage device of claim 15, wherein the program instructions, upon execution by the processor, further cause the IHS to generate an alias signing key that is void of any personally identifiable information (PII) associated with a user of the computing device; send the alias signing key to the federated learning service, wherein the federated learning service used the alias signing key to attest the local learning service.
